(19) United States
(12) Patent Application Publication
(10) Pub. No.: US 2012/0150913 A1
(43) Pub. Date: Jun. 14, 2012

(54) MULTIDIMENSIONAL DATA-CENTRIC SERVICE PROTOCOL

(75) Inventors: Bart De Smet, Bellevue, WA (US); Henricus Johannes Maria Meijer, Mercer Island, WA (US)

(73) Assignee: MICROSOFT CORPORATION, Redmond, WA (US)

(21) Appl. No.: 12/966,596

(22) Filed: Dec. 13, 2010

(51) Int. Cl. G06F 17/30

(52) U.S. Cl. 707/792; 707/E17.056

(57) ABSTRACT

Data acquisition is facilitated by way of an intermediate representation of a query expression. The intermediate representation can be generated and subsequently transmitted to, and employed by, a plurality of execution environments with respect to query execution. More particularly, the intermediate representation can be transformed into a locally executable query expression. Furthermore, numerous factors can shape the created and transmitted intermediate representation.

### BACKGROUND

Data processing is a fundamental part of computer programming. One can choose from amongst a variety of programming languages with which to author programs. The selected language for a particular application may depend on the application context, a developer's preference, or a company policy, among other factors. Regardless of the selected language, a developer will ultimately have to deal with data, namely querying and updating data.

A technology called language-integrated queries (LINQ) was developed to facilitate data interaction from within programming languages. LINQ provides a convenient and declarative shorthand query syntax to enable specification of queries within a programming language (e.g., C#®, Visual Basic® . . . ). More specifically, query operators are provided that map to lower-level language constructs or primitives such as methods and lambda expressions. Query operators are provided for various families of operations (e.g., filtering, projection, joining, grouping, ordering . . . ), and can include but are not limited to “where” and “select” operators that map to methods that implement the operators that these names represent. By way of example, a user can specify a query expression in a form such as “from n in numbers where n<10 select n,” wherein “numbers” is a data source and the query returns integers from the data source that are less than ten. Further, query operators can be combined in various ways to generate queries of arbitrary complexity.

There can be a client-server relationship to query processing where the client generates the query and the server executes the query. Moreover, differences can exist between execution environments of clients and servers, often referred to as an impedance mismatch. This impedance mismatch is bridged by transforming a client representation of a query directly to a target-server comprehensible form. For example, a query expression integrated within a general-purpose programming language (e.g., C#®, Visual Basic®, Java . . . ) can be translated to domain-specific programming language such as T-SQL (e.g., Transact-Structured Query Language) to enable execution with respect to a relational database system. This can be accomplished utilizing intimate knowledge of a query source and an execution target to map between the source and the target.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to multidimensional data centric service protocol. An intermediate representation of a query expression can be generated that is independent of query-expression generation and execution environments. In other words, the intermediate representation is generated without domain specific knowledge. The intermediate representation can subsequently be provided to a query execution service, which can transform the intermediate representation to a locally executable representation. Subsequently, the query expression can be executed and results returned. Accordingly, the intermediate representation provides a uniform vehicle for exchange of query expressions across a plurality of different execution environments.

Furthermore, a number of features can be employed with respect to the intermediate representation. For example, at least a portion of the intermediate representation can be discarded as a function of a particular execution context (e.g., dynamically typed). In addition, client context information can be transmitted in conjunction with the intermediate expression to enable decisions regarding query execution to be made based thereon. Further yet, various compression techniques can be utilized to reduce the overall size of the query expression and/or representation thereof prior to transmission.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data acquisition system.

FIG. 2 is a block diagram of a representative communication component.

FIG. 3 is a block diagram of a system that facilitates data acquisition.

FIG. 4 illustrates a concrete example of a data-centric protocol.

FIG. 5 is a flow chart diagram of a method of data acquisition.

FIG. 6 is a flow chart diagram of a method of provisioning data.

FIG. 7 is a flow chart diagram of a method of providing data-centric services.

FIG. 8 is a schematic block diagram illustrating a suitable operating environment for aspects of the subject disclosure.

### DETAILED DESCRIPTION

Details below are generally directed toward multidimensional data-centric service protocol. Various services can be available for processing requests for data. For example, a number of servers can be accessible to network connected clients to execute query expressions, or more simply stated, queries. Rather than translating a query expression directly from a source format to a target format, an intermediate representation of a query expression can be generated for use with respect to a plurality of execution environments. Subsequently, the intermediate representation can be transmitted to a query execution environment, which can transform the intermediate representation into a locally executable form. In this manner, intricate details regarding an execution environment need not be known, which can allow a query to be potentially executed in any execution context. In addition, the intermediate representation can insulate a query expression generator from changes with respect to a query executor (e.g., data source schema changes), among other things.

Furthermore, numerous factors can also shape the created and transmitted intermediate representation. For example, where portions of the intermediate representation are not supported by an execution environment, the portions can be removed prior to transmission. Additionally, client context information can be added to the intermediate representation to enable an execution environment to employ such data in various manners. Further yet, at least portions of the query expression can be compressed to facilitate transmission. In other words, the protocol can be multidimensional.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

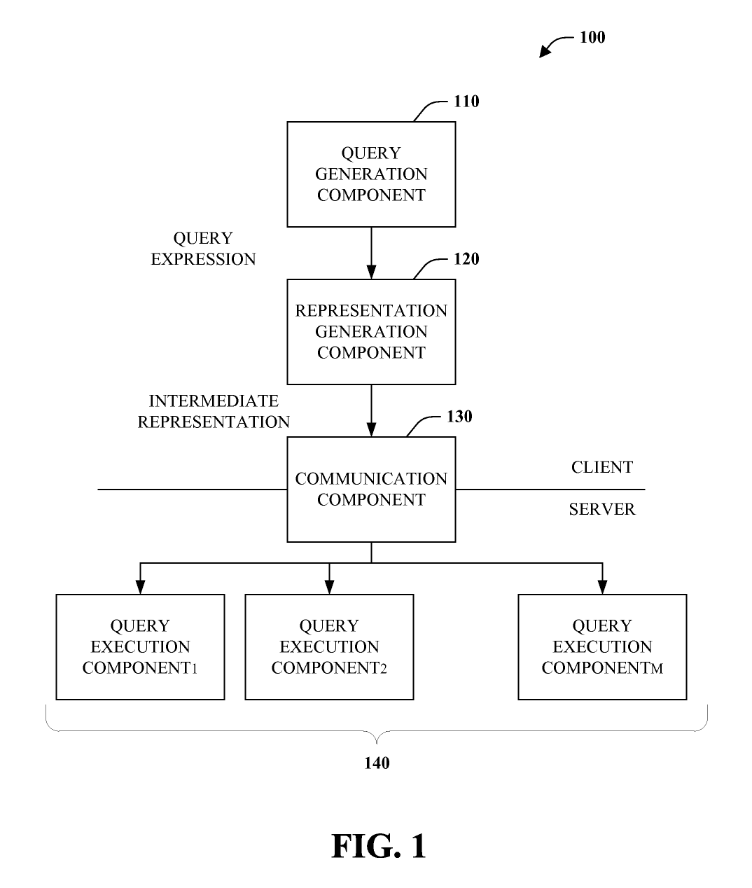

Referring initially to FIG. 1, a data acquisition system 100 is illustrated that includes a query generation component 110, a representation generation component 120, a communication component 130, and a plurality of query execution components 140 (1-M, where M is a positive integer). The query generation component 110 and the representation generation component 120 can form part of a client query-generation environment, and the query execution components 140 can from part of a server query-execution environment, wherein environment refers to an underlying platform or context (e.g., hardware/software) in which generation or execution takes place. The communication component 130 enables communication between the client query-generation environment and the server query-execution environment.

The query generation component 110 produces a local representation of a query expression (e.g. a combination of one or more values and/or operators). For example and although not limited thereto, a query expression can correspond to a language-integrated query (LINQ or LINQ query) that is specified with respect to a combination of query operators, and the generated local representation can be an expression tree. Furthermore, the query expression can optionally be segmented into two or more query expressions to enable distributed query execution. For clarity and simplicity, however, this description focuses a single query expression, which can be one of a number of sub-query expressions designated for distributed execution.

The representation generation component 120 receives, retrieves, or otherwise obtains or acquires a query expression, which specifies a query with respect to one or more data sources, and produces an intermediate representation of the query expression that is query-expression generation and execution environment independent (e.g., without domain-specific knowledge). Nevertheless, the intermediate representation captures the semantics (e.g., meaning) of the query expression implied by an ordering of one or more query operators (e.g., via type information, method calls . . . ). For example, if the client representation of a query expression is an expression tree, the representation generation component 120 can iterate through nodes of the tree and generate equivalent code that is not tied to a particular execution context (e.g., hardware or software). In one particular instance, type information can be generated at different levels of granularity since information can be determined or inferred and reconstructed. In other words, the intermediate representation is a domain-independent vehicle of knowledge exchange between the client query-generation environment and the server query-execution environment. Furthermore, the representation generation component 120 can include metadata in the intermediate representation such as client context information as described later herein.

The communication component 130 provides a means for facilitating communication of the intermediate representation to one or more query execution components 140. As will be described later herein, the communication component 130 can enable negotiation of a particular protocol between the client query-generation environment and server query-execution environment with respect to the intermediate representation.

The query execution components 140 can include execution contexts (e.g., supported hardware/software) that differ from the execution context in which the query expression was constructed. For example, the query expression can be constructed with a first programming language while a query execution component 140 supports second programming language. Further, execution context can vary amongst the query execution components 140 as well. Nevertheless, each query execution component 140 can transform the intermediate representation of a query expression into a representation executable within its particular context.

Employment of an intermediate representation is beneficial in that it provides a uniform interface for data acquisition. In other words, a single intermediate representation can be produced rather than a numerous representations targeting particular query execution contexts. Along the same lines, a query generator need not have knowledge of the intricacies of particular query contexts to interact with the contexts, and certain query expressions can be rejected during transformation to the intermediate representation. As well, a query expression generation is insulated with respect to changes with respect to a query execution component 140 (e.g., context, schema, version . . . ). Still further yet, the intermediate representation can facilitate distributed as well as parallel processing since the representation can be common for multiple query execution components. By way of example, a query execution component 140 can provide the intermediate representation to yet another query execution component 140 for execution of at least a portion of the query expression represented thereby.

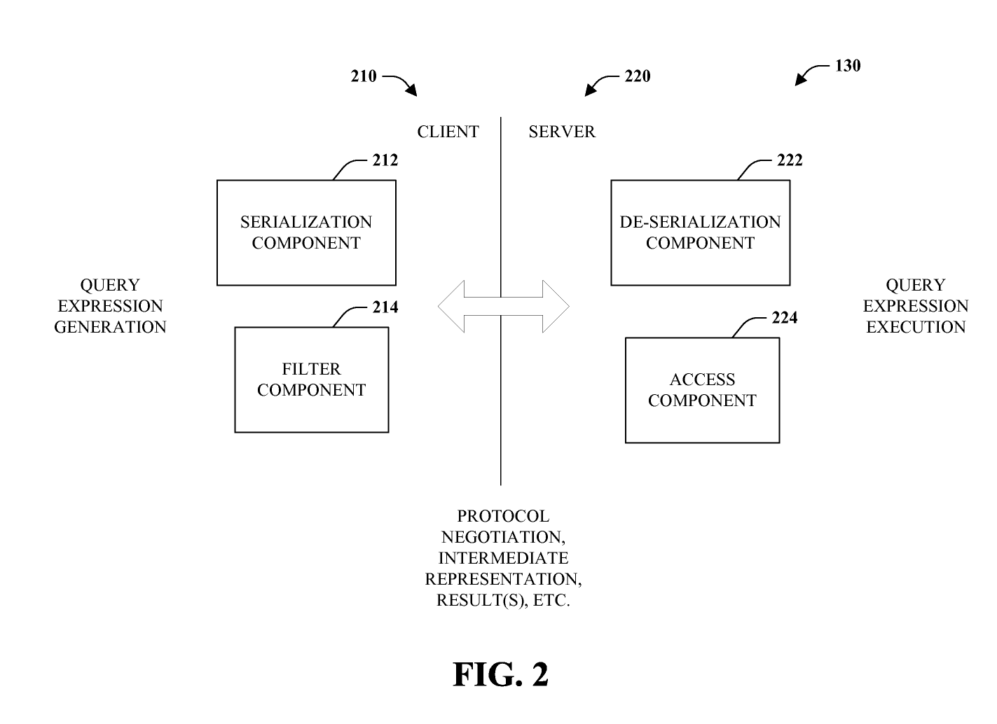

FIG. 2 details a representative communication component 130. Query expression generation and query expression execution can be performed by two distinct entities. Here, query expression generation can correspond to a client 210 activity whereas query expression execution can correspond to activity of a server 220. Of course, the server 220 can also be a client 210 to another server 220. Since the communication component 130 facilitates communication between a query expression generator and a query expression executor, or in other words a client 210 and a server 220, each of the client 210 and server 220 can include various sub-components related to communication. More specifically, the client 210 can include a serialization component 212 and the server 220 can include a de-serialization component 222. The serialization component 212 serializes a query expression, or in other words transforms the query expression to a series of bits that can be transmitted across a communication framework (e.g., Internet). The de-serialization component 222 can reconstruct the query expression from the series of bits. In accordance with one embodiment, the intermediate representation of a query expression can be serialized. Alternatively, the serialized format can correspond to the intermediate format. Further, the de-serialization component 222 can include mapping functionality that maps or transforms the de-serialized query expression to a format executable by the server 220. For example, after resulting code is generated it can be executed directly (e.g., using an “eval” function) or turned into a compiled form for subsequent execution. Still further yet, it is to be noted that the client 210 and server 220 can optionally negotiate a serialization format, rather than relying on a default serialization format, for instance.

A filter component 214 can also reside on the client side and include functionality to remove portions of an intermediate representation of a query expression. For example, the filter component 214 can initiate communication with the server 220 and request information regarding supported scope of a query expression including functionality, capabilities, or the like. Based at least in part on this information the filter component 214 is configured to remove portions of the intermediate representation prior to transmission. Since the intermediate representation is designed for use by multiple query executors of various sophistication and capabilities, some information such as data types might be useful in one context but be unused in another context. Accordingly, the filter component 214 can reduce the amount of data transmitted as a function of a particular execution context. In other words, the filter component 214 can perform a type of lossy compression with respect to the intermediate representation as a function of execution context. Further, it is to be appreciated that the server 220 may distribute a query execution work to other servers. In this case, upon inquiry from the filter component 214, the server 220 can respond with information that captures the maximum quantity of data needed by it or other servers it intends to employ to ensure requisite information is available. Of course, additional communication can be initiated to obtain information that was discarded prior to transmission.

In accordance with one embodiment, the intermediate representation of a query expression and/or its serialized form can include information about the client 210 wherein the client can refer to a particular computer and/or user of the computer (e.g., identity, login information . . . ). The access component 224 can acquire this information from the intermediate representation and utilize the information to control access to query expression execution functionality. In some sense, the server 220 is providing a service or more particularly data-centric services, such as a query execution service. Access to the service can be controlled for safety, security, and/or monetization reasons, among other things. For example, if an individual requests query execution and does not have a subscription to the service, the access component 224 can prevent the server 220 from executing the query and/or returning results. Similarly, the access component 224 can keep track of the number of queries executed by a client 210 for analysis and/or billing reasons where subscriptions are offered with fees tied to a number of queries (e.g., per week, per month . . . ).

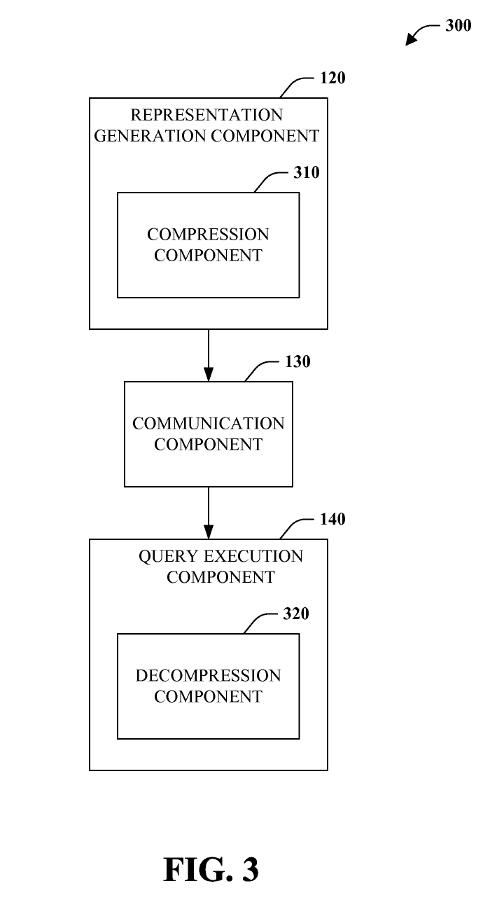

FIG. 3 is a block diagram of a system 300 that facilitates data acquisition. Similar to system 100 of FIG. 1, the system 300 includes the representation generation component 120, the communication component 130, and the query execution component 140. In brief, the representation generation component 120 produces an intermediate representation of query expression that is communicated by way of communication component 130 to the query execution component 140 that utilizes the intermediate representation to produce a locally executable representation thereof In addition, the representation generation component 120 includes a compression component 310 and the query execution component can include a corresponding decompression component 320. The compression component 310 compresses, or in other words, reduces the size of a generated intermediate representation by applying a compression function that encodes information using few bits. The decompression component 320 can be configured to restore information to its form prior to compression, or stated different the decompression component 320 can reverse the effects of compression. In accordance with one embodiment, the compression component can operate over a query expression or intermediate representation prior to serialization so as not to be limited to conventional compression schemes over text (e.g., Zip file format). Furthermore, it should be appreciated that during a protocol negotiation a particular compression function or the like can be agreed upon. Alternatively, a standard compression function can be utilized across all query expressions. In any event, by utilizing compression the size of the intermediate file can be reduced thus reducing the amount of data that needs to be transmitted and the speed at which the totality of data is transmitted.

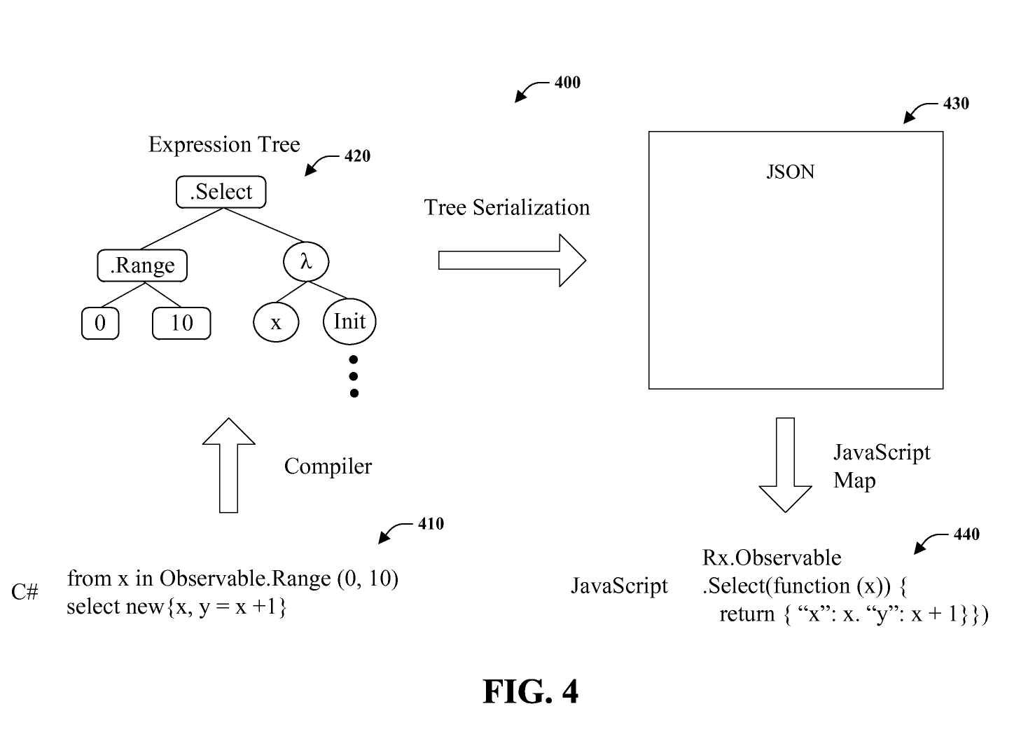

FIG. 4 illustrates an exemplary concrete scenario to facilitate clarity and understanding with respect to aspects of the claimed subject matter. A query expression 410 can be specified on a client with a programming language such as C#®. For example, the query expression 410 can be embodied as a language-integrated query (LINQ or LINQ query). Upon compilation by a respective compiler, an expression tree representation 420 of the query expression can be produced on the client. From the expression tree representation 420, a serialized intermediate representation 430 can be generated. Here, the serialized intermediate representation is in JSON (JavaScript Object Notation) format. Of course, other formats can also be employed such as but not limited to XML (eXtensible Markup Language). Finally, a JavaScript representation of the query expression 440 can be generated from the intermediate representation 430. Here, JavaScript is the execution context associated with query executor. As previously mentioned, however, the intermediate representation 430 can be mapped, or in other words transformed, for use in a plurality of different execution environments.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the communication component 130 can utilizes such mechanisms to determine or infer an optimal communication protocol as a function of historical and/or contextual information, for instance.

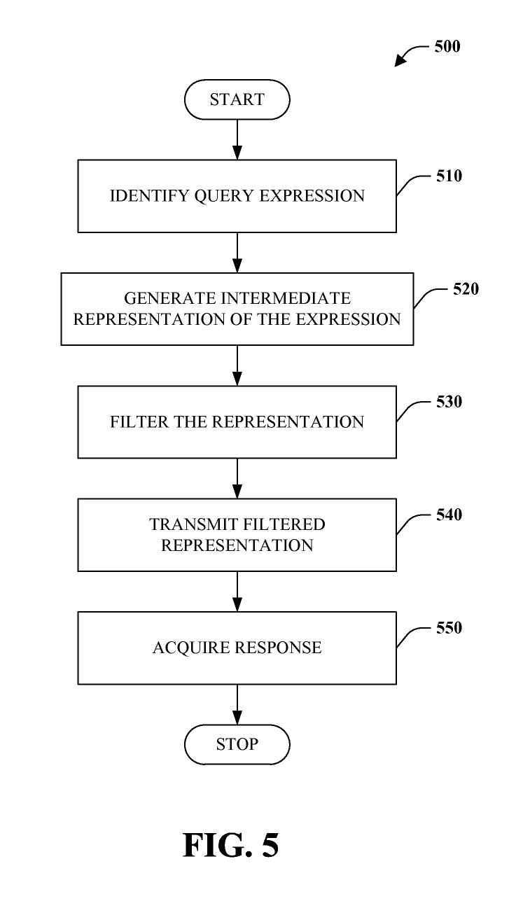

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 5, a method of data acquisition 500 is illustrated. At reference numeral 510, a query expression is identified. By way of example, the query expression can be in a local client form (e.g., expression tree) produced from a language-integrated query. At reference numeral 520, an intermediate representation of the query expression is generated independent of any particular query generation or execution context, environment, or the like, wherein the intermediate representation maintains query expression semantics. Stated differently, the intermediate representation can be generated without any domain-specific information. At numeral 530, the intermediate representation is filtered as a function of target execution context (e.g., domain specific knowledge). In other words, portions of the intermediate representation not supported by the execution context can be discarded. For example, a server can provide information about its execution context and based thereon the intermediate representation can be stripped of particular unneeded information such as type information. This is analogous to lossy compression, where data is lost in reducing the size of a file to facilitate storage or transmission thereof. By way of example, Appendix A provides an intermediate representation for the following query expression excluding type information: “Qbservable.Range(0, 10).Where(x=>×% 2==0).Select(x=>×+1).” At reference numeral 540, transmission of the filtered intermediate representation is at least initiated. At numeral 550, a response is received, retrieved, or otherwise obtained or acquired corresponding to the result(s) of query expression execution.

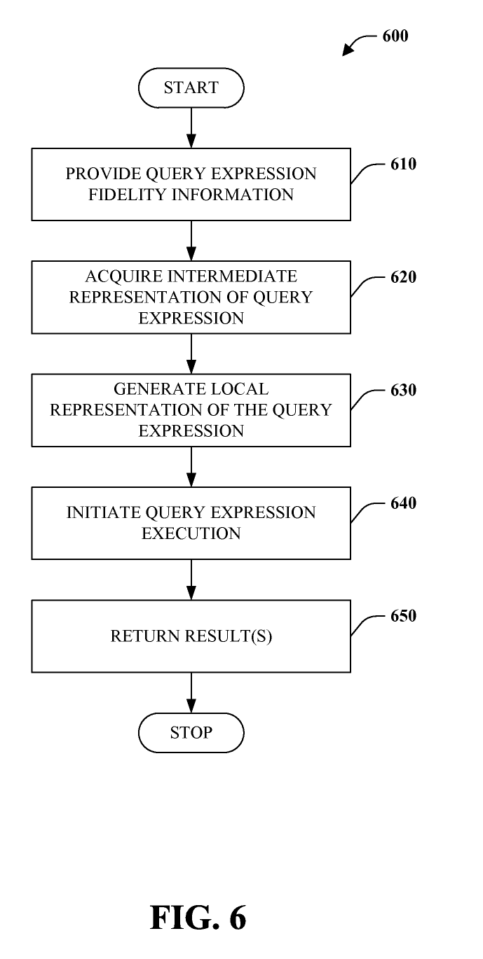

FIG. 6 depicts a method 600 of provisioning data, for example by a server. At reference numeral 610, query expression fidelity information can be provided, for example to a requesting client. The query-expression fidelity information comprises information regarding the supported scope of a query expression that is useful in a filtering operation that reduces the size of a query expression representation based on execution context and/or capabilities, among other things. At reference numeral 620, an intermediate representation, uniform with respect to multiple execution contexts, is acquired. At 630, a local representation of the query expression is generated from the intermediate query representation. Such generation can involve utilizing a map from the intermediate query representation to a local execution context. At numeral 640, query expression execution, or in other words, evaluation is at least initiated. At reference numeral 650, return of one or more results of the query expression execution is at least initiated with respect to a query-execution requesting party.

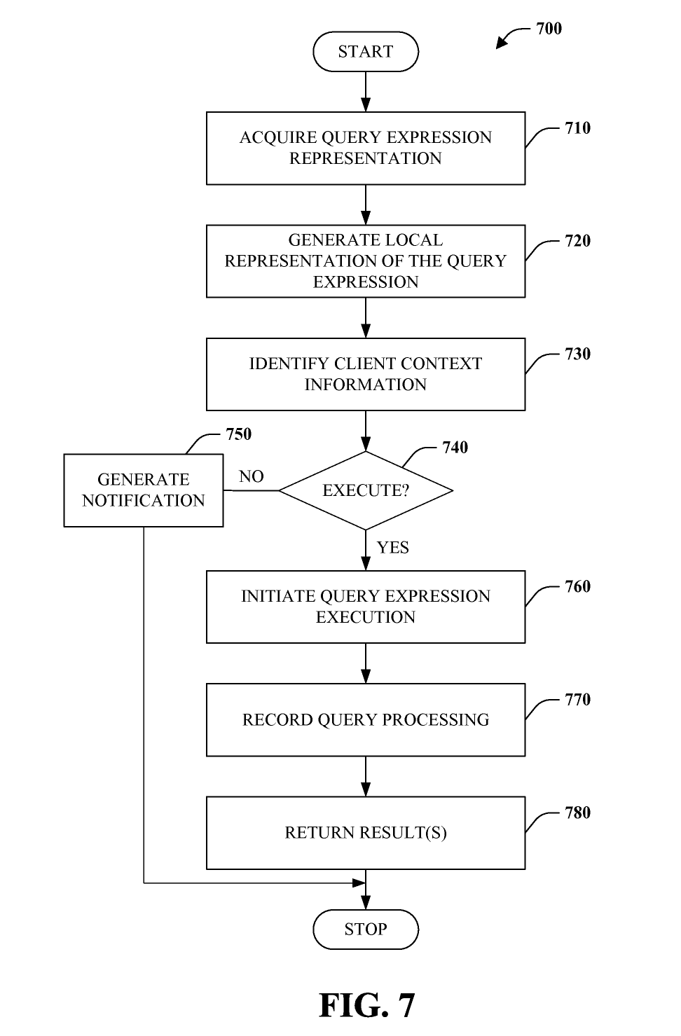

FIG. 7 is a flow chart diagram illustrating a method 700 of providing data-centric services. At reference numeral 710, an intermediate representation of a query expression is received, retrieved, or otherwise obtained or acquired. At numeral 720, a local representation of the query expression is generated from the intermediate representation. At reference 730, client context information is identified, for example from the intermediate representation. Such context information can concern a particular computer and/or computer user requesting service with respect to query execution.

At 740, a determination is made concerning whether to execute the query expression. Such a determination can be made as a function of safety and/or security concerns as well as subscription information, among other things. For example, if client information indicates that the request is coming from a known security risk or a maximum number of queries have already been processed, a decision can be made not to execute the query. If, however, the client information indicates that the request arises from a user with a valid subscription, the decision can be to execute the query. Still further yet, the determination at 740 can correspond more generally to a filter such that parts of the query expression are allowed to execute while others are not. In one instance, a negotiation can occur where a client agrees to obey server communicated restrictions, and thus the entire query expression is likely to be allowable. Alternatively, an agreement can be made where the server accepts arbitrary queries (or a subset thereof) but can come to the conclusion during processing that a condition exists that prevents execution of the query in its entirety.

If, at 740, a decision is made not to execute the query (“NO”) (or portion thereof), a notification of this fact can be generated at 750 and potentially provided to a requesting party. Further, although not illustrated, results from other parts of a query that were allowed to execute can be returned. Subsequently, the method 700 can terminate. If, however, at 740, the decision is to allow execution (“YES”) then the method 700 continues at numeral 760 where query execution is at least initiated. Continuing at reference numeral 770, usage information such as the fact that query was executed can be recorded along with information regarding client context, for example for later analysis or use in determining subscription compliance based on a set number of queries (e.g., 100 queries per month). Next, at 780, return of one or more results of query execution can be at least initiated.

As used herein, the terms “component,” “system,” and “engine” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

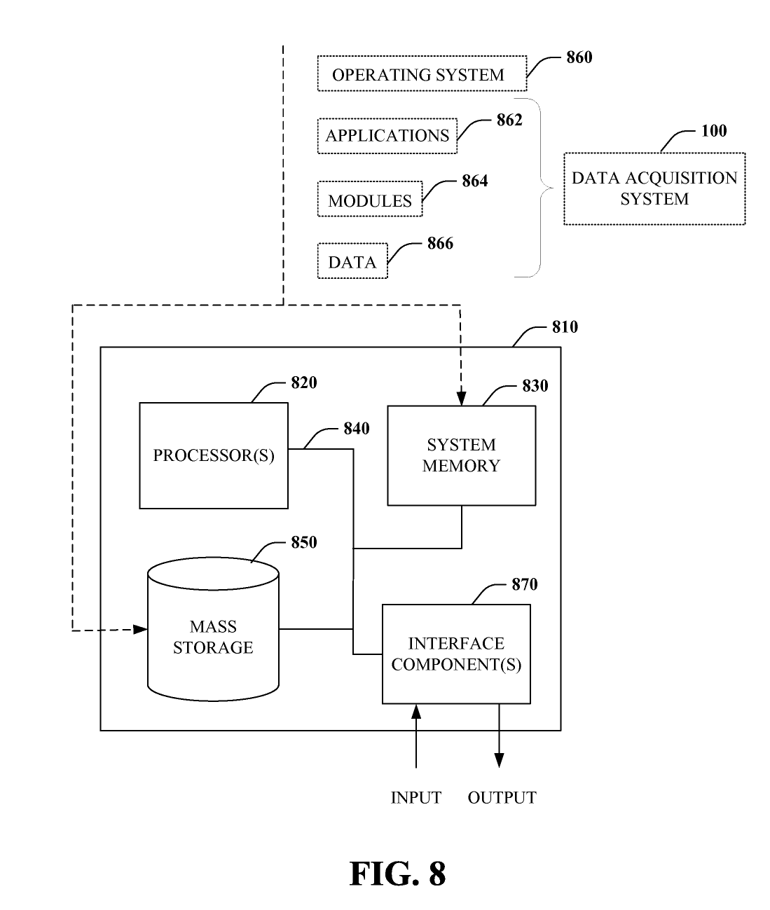

In order to provide a context for the claimed subject matter, FIG. 8 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 8, illustrated is an example general-purpose computer 810 or computing device (e.g., desktop, laptop, server, hand-held, programmable consumer or industrial electronics, set-top box, game system . . . ). The computer 810 includes one or more processor(s) 820, memory 830, system bus 840, mass storage 850, and one or more interface components 870. The system bus 840 communicatively couples at least the above system components. However, it is to be appreciated that in its simplest form the computer 810 can include one or more processors 820 coupled to memory 830 that execute various computer executable actions, instructions, and or components stored in memory 830.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration.

The computer 810 can include or otherwise interact with a variety of computer-readable media to facilitate control of the computer 810 to implement one or more aspects of the claimed subject matter. The computer-readable media can be any available media that can be accessed by the computer 810 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 810.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 830 and mass storage 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 810, such as during start-up, can be stored in nonvolatile memory, while volatile memory can act as external cache memory to facilitate processing by the processor(s) 820, among other things.

Mass storage 850 includes removable/non-removable, volatile/non-volatile computer storage media for storage of large amounts of data relative to the memory 830. For example, mass storage 850 includes, but is not limited to, one or more devices such as a magnetic or optical disk drive, floppy disk drive, flash memory, solid-state drive, or memory stick.

Memory 830 and mass storage 850 can include, or have stored therein, operating system 860, one or more applications 862, one or more program modules 864, and data 866. The operating system 860 acts to control and allocate resources of the computer 810. Applications 862 include one or both of system and application software and can exploit management of resources by the operating system 860 through program modules 864 and data 866 stored in memory 830 and/or mass storage 850 to perform one or more actions. Accordingly, applications 862 can turn a general-purpose computer 810 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the data acquisition system 100, or portions thereof, can be, or form part, of an application 862, and include one or more modules 864 and data 866 stored in memory and/or mass storage 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the data acquisition system 100 and/or associated functionality can be embedded within hardware in a SOC architecture.

The computer 810 also includes one or more interface components 870 that are communicatively coupled to the system bus 840 and facilitate interaction with the computer 810. By way of example, the interface component 870 can be a port (e.g., serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 810 through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., CRT, LCD, plasma . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims

APPENDIX A
{

Type: “Call”,
Method: “Qbservable.Select”,
Arguments: [

{

Type: “Call”,
Method: “Qbservable.Where”,
Arguments: [

{

Type: “Call”,
Method: “Qbservable.Range”,
Arguments: [

{ Type: “Constant”, Value: “0” },
{ Type: “Constant”, Value: “10” }

]

},
{

Type: “Lambda”,
Body: {

Type: “Equal”,
Left: {

Type: “Modulo”,
Left: { Type: “Parameter”, Name:
“x” },
Right: { Type: “Constant”, Value:
“2” }

},
Right: { Type: “Constant”, Value: “0” }

},
Parameters: [

{ Type: “Parameter”, Name: “x” }

]

}

]

},
{

Type: “Lambda”,
Body: {

Type: “Add”,
Left: { Type: “Parameter”, Name: “x” },
Right: { Type: “Constant”, Value: “1” }

},
Parameters: [

{ Type: “Parameter”, Name: “x” }

]

}

What is claimed is:

1. A method of acquiring data, comprising:
employing at least one processor configured to execute computer-executable instructions stored in memory to perform the following acts:
generating an intermediate representation of a query expression that is independent of query-expression generation and execution environments.

2. The method of claim 1 further comprises removing a portion of the intermediate representation as a function of an execution environment.

3. The method of claim 1 further comprises incorporating client context information into the intermediate representation.

4. The method of claim 1 further comprises compressing the intermediate representation.

5. The method of claim 1 further comprises initiating transmission to an execution environment.

6. The method of claim 5 further comprises receiving a result of query expression execution from the execution environment.

7. A method of servicing requests for data, comprising:
employing at least one processor configured to execute computer-executable instructions stored in memory to perform the following acts:
generating a local representation of a query expression from an intermediate representation of the query expression, wherein the intermediate representation is independent of a query-expression generation and execution environments.

8. The method of claim 7 further comprises transmitting information regarding supported scope of the query expression.

9. The method of claim 8 further comprises determining a minimal requisite scope from amongst two or more execution environments.

10. The method of claim 7 further comprises distributing at least a portion of the query expression by way of the intermediate representation for external processing.

11. The method of claim 7 further comprises decompressing the query expression.

12. The method of claim 7 further comprises extracting client context information from the intermediate representation.

13. The method of claim 12 further comprises determining whether to execute the query expression as a function of the client context information.

14. The method of claim 12 further comprises tracking a usage by a specific individual as a function of the client context information.

15. The method of claim 7 further comprises initiating processing of the query expression.

16. A data acquisition system, comprising:
a processor coupled to a memory, the processor configured to execute the following computer-executable components stored in the memory:
a first component configured to generate a local representation from an intermediate representation of a query expression, wherein the intermediate representation is generated without domain-specific knowledge; and
a second component configured to initiate execution of the local representation.

17. The system of claim 16 further comprises a third component configured to determine client context information from the intermediate representation.

18. The system of claim 17, the third component is configured to prohibit initiation of execution based on the client context information.

19. The system of claim 16, the intermediate representation excludes code unsupported by an execution environment.

20. The system of claim 16, distributed execution is initiated by the second component.
